(19) United States
(12) Patent Application Publication
(10) Pub. No.: US 2007/0019657 A1
(43) Pub. Date: Jan. 25, 2007

(54) Network apparatus and method of specifying network parameter

(76) Inventor: Hajime Takayama, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/487,452

(22) Filed: Jul. 17, 2006

(30) Foreign Application Priority Data
Jul. 19, 2005 (JP) 2005-208635

(51) Int. Cl. H04L 12/56

(52) U.S. Cl. 370/401; 370/254; 709/223

(57) ABSTRACT

A network apparatus configured to communicate with a terminal using an IP address includes an information acquisition control unit configured to obtain a first IP address to be used by the terminal to specify a parameter in a network configuration; and a setting form generation unit configured to generate a setting screen which is to be used by the terminal to set up the network configuration and provides the terminal with the obtained first IP address.

### BACKGROUND OF THE INVENTION

1. Field of the Invention

The present invention generally relates to a network apparatus and a method of specifying a network parameter, and more particularly relates to a network apparatus which communicates by using an IP address and a method of specifying a network parameter using a terminal.

2. Description of the Related Art IPv6 is starting to be used. In IPv6, the length of an IP address is 128 bits. Therefore, IPv6 provides an extremely large address space compared with the address space in IPv4. Also, in IPv6, various communication security measures such as IPSec are provided.

IPSec is a security protocol and provides authentication and encryption. For communication using IPSec, an authentication method and an encryption method, for example, must be set at terminals to be used in the communication.

Such a setting operation for IPSec involves entering IP addresses. However, manually entering an IPv6 IP address with a length of 128 bits is burdensome for a user and may increase the possibility of an input error.

In an IPv6 address, :: can be used to indicate a series of zeros. For example, 2001:0:0:0:0:0:0:1 can be expressed as 2001::l. Such a notation rule may reduce the burden of entering an IPv6 address. However, when a large number of IPv6 addresses come to be used as IPv6 becomes widespread, the notation rule alone cannot solve the problem.

Since entering an IPv6 address is required not only in IPSec setting but also in various network setting operations such as static routing information setting, the burden of entering an IPv6 address is being one of the hurdles preventing the widespread adoption of IPv6.

### SUMMARY OF THE INVENTION

The present invention provides a network apparatus and a method of specifying a network parameter that substantially obviate one or more problems caused by the limitations and disadvantages of the related art.

Embodiments of the present invention provide a network apparatus and a method of specifying a network parameter which make it easier for a user to specify network settings.

According to an embodiment of the present invention, a network apparatus configured to communicate with a terminal using an IP address includes an information acquisition control unit configured to obtain a first IP address to be used by the terminal to specify a parameter in a network configuration; and a setting form generation unit configured to generate a setting screen which is to be used by the terminal to set up the network configuration and provides the terminal with the obtained first IP address.

According to an aspect of the present invention, the information acquisition control unit obtains the first IP address by using SNMP.

According to an aspect of the present invention, the network apparatus further includes a setting information verification unit configured to verify a second IP address specified using the setting screen by the terminal.

According to an aspect of the present invention, the setting information verification unit verifies the second IP address specified by the terminal based on information contained in a packet sent from the terminal.

According to an aspect of the present invention, the setting information verification unit verifies the second IP address specified by the terminal based on information obtained by using SNMP.

According to an aspect of the present invention, the setting information verification unit uses identifiers linked to the first IP address and the second IP address to verify the second IP address.

According to an aspect of the present invention, the network apparatus further includes a setting information retaining unit configured to retain the first IP address and the identifier linked to the first IP address.

According to an aspect of the present invention, the network apparatus further includes a setting information management unit configured to manage the first IP address and the identifier linked to the first IP address which are retained by the setting information retaining unit.

According to an aspect of the present invention, the setting information management unit removes after a specified period of time the first IP address and the identifier linked to the first IP address which are retained by the setting information retaining unit.

According to another embodiment of the present invention, a method of specifying a network parameter using a terminal includes an information acquisition step of obtaining a first IP address to be used by the terminal to specify a parameter in a network configuration; and a setting form generation step of generating a setting screen which is to be used by the terminal to set up the network configuration and provides the terminal with the obtained first IP address.

As described above, embodiments of the present invention provide a network apparatus and a method of specifying a network parameter which make it easier for a user to enter IP addresses.

### BRIEF DESCRIPTION OF THE DRAWINGS

FIG. 1 is a drawing illustrating an exemplary network configuration used to describe an embodiment of the present invention;

FIG. 2 is a block diagram illustrating an exemplary software configuration of a printer;

FIG. 3 is a sequence diagram illustrating communication between a printer and a terminal;

FIG. 4 is a drawing illustrating an exemplary setting screen;

FIG. 5 is a drawing illustrating an exemplary setting screen where an IP address list is displayed;

FIG. 6 is a drawing illustrating an exemplary setting screen used to describe how to rewrite an initial value;

FIG. 7 is a drawing illustrating an exemplary setting screen where an IP address list including no local address is displayed;

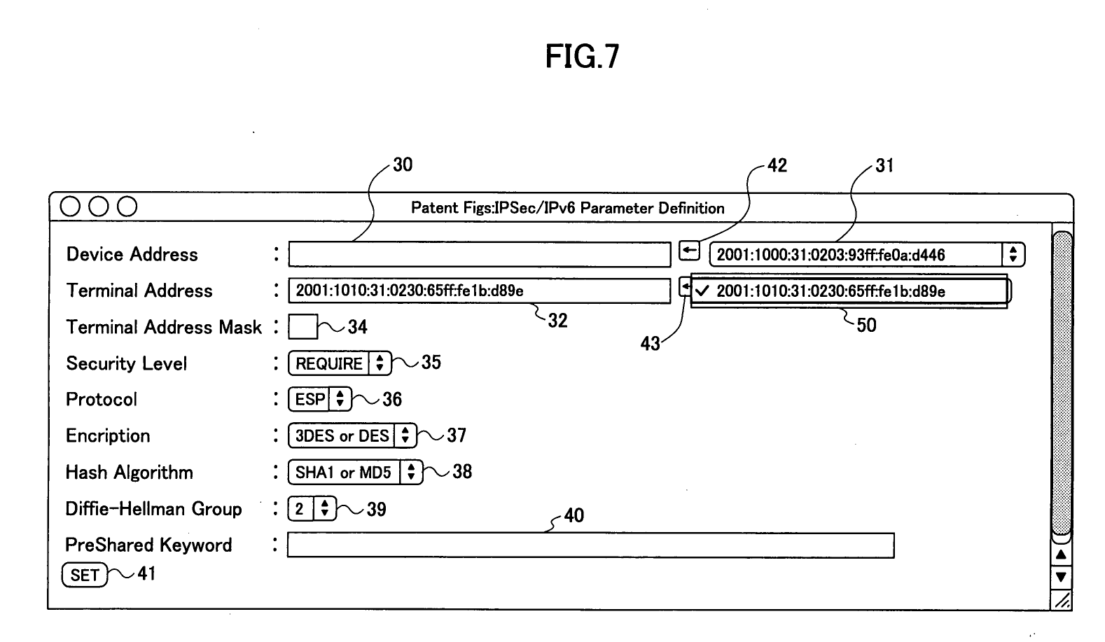

FIG. 8 is a drawing illustrating an exemplary static routing information setting screen;

FIG. 9 is a drawing illustrating an exemplary static routing information setting screen where an IP address list is displayed;

FIG. 10 is a drawing used to describe an exemplary process of obtaining IP addresses of routers;

FIG. 11 is a drawing illustrating exemplary information for initial values and exemplary identifiers;

FIG. 12 is a drawing illustrating an exemplary conventional static routing information setting screen where an IP address setting error is detected; and

FIG. 13 is a drawing illustrating an exemplary static routing information setting screen according to an embodiment of the present invention where an IP address setting error is detected.

### DESCRIPTION OF THE PREFERRED EMBODIMENTS

Preferred embodiments of the present invention are described below with reference to the accompanying drawings. In this embodiment, for descriptive purpose, a printer is used as an example of a network apparatus and a Web browser using HTTP is used to specify network settings.

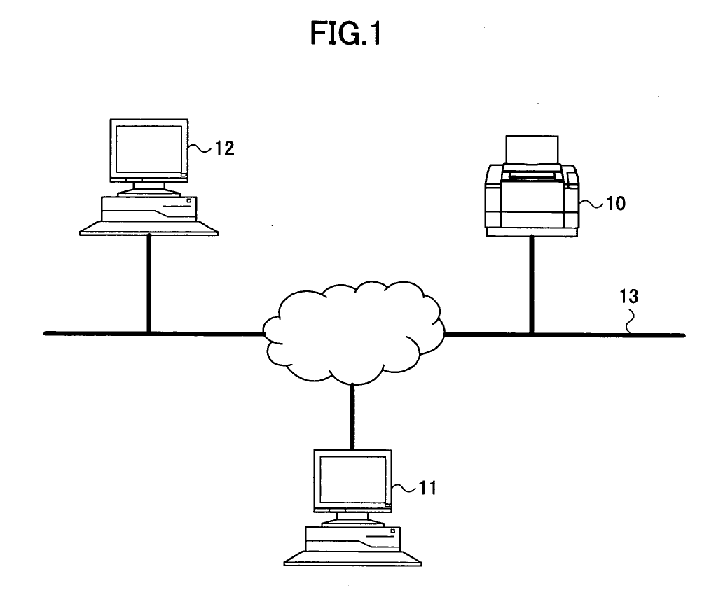

FIG. 1 is a drawing illustrating an exemplary network configuration used to describe an embodiment of the present invention. The exemplary network configuration shown in FIG. 1 includes a printer 10, terminals 11 and 12, and a network 13 connecting them. Although the printer 10 and the terminals 11 and 12 are in the same network segment in FIG. 1, they may be in different network segments connected by a router or the like.

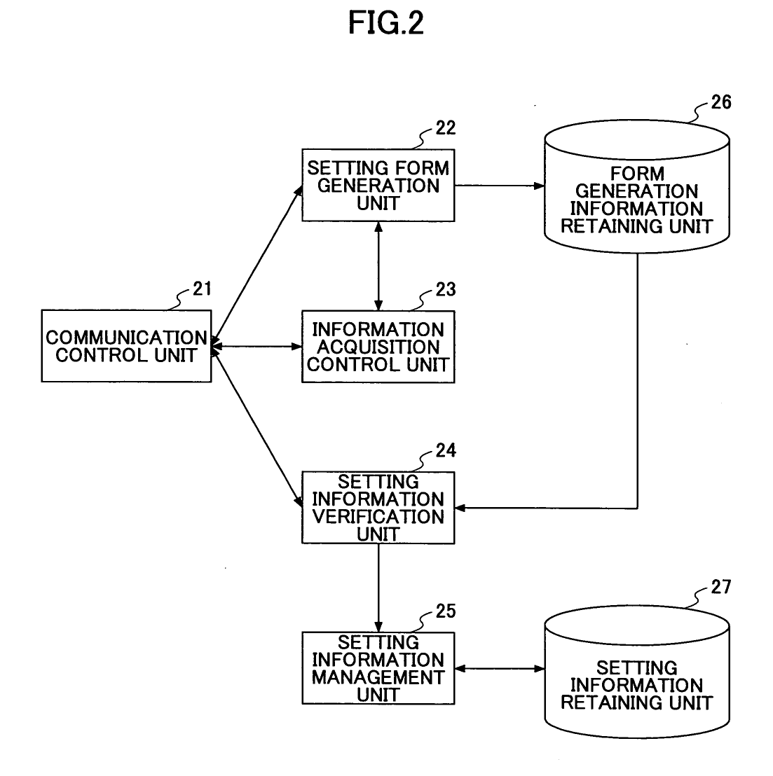

An exemplary software configuration of the printer 10 is described below with reference to FIG. 2. The exemplary software configuration of the printer 10 shown in FIG. 2 includes a communication control unit 21, a setting form generation unit 22, an information acquisition control unit 23, a setting information verification unit 24, a setting information management unit 25, a form generation information retaining unit 26, and a setting information retaining unit 27.

The communication control unit 21 controls communication via the network 13. The setting form generation unit 22 generates a form of a setting screen to be displayed on a terminal. The form generation information retaining unit 26 retains the information relating to the form generated by the setting form generation unit 22. The information acquisition control unit 23 controls acquisition of terminal information. The setting information verification unit 24 verifies settings specified by a terminal. The setting information retaining unit 27 retains settings specified by a terminal. The setting information management unit 25 manages the setting information retaining unit 27.

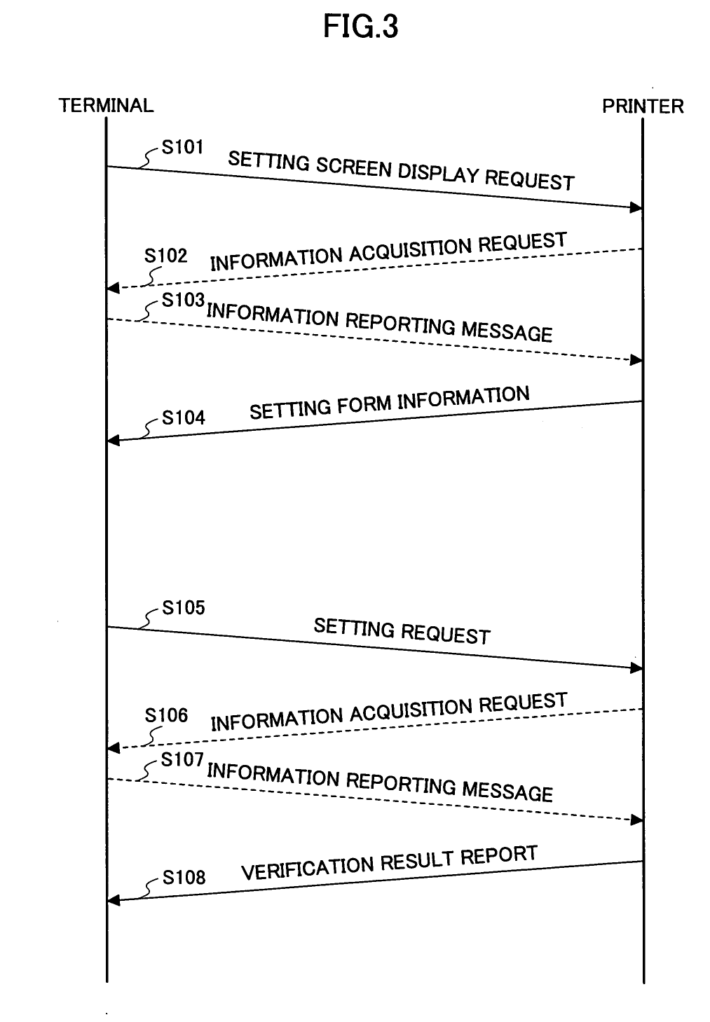

Communication between a printer and a terminal is described below with reference to a sequence diagram shown in FIG. 3. In step S101, the terminal sends a setting screen display request to the printer. In step S102, in response to the setting screen display request, the printer sends an information acquisition request to the terminal to obtain information of the terminal. In step S103, the printer obtains the terminal information from an information reporting message sent from the terminal. In step S104, based on the information obtained from the information reporting message, the printer generates a setting form and sends the setting form information to the terminal.

The setting screen display request made in step S101 may be a request to access the URL of a setting screen using HTTP. For the access to the URL of a setting screen, either IPv4 or IPv6 may be used. For the information acquisition request made in step S102 to the terminal, SNMP may be used.

Whether IPv4 or IPv6 is used to send the setting screen display request, the printer can send the information acquisition request to the address from which the setting screen display request is sent. Also, the setting screen display request in step S101 may be broadcast to the network, depending on the content of the setting screen display request. The terminal information obtained in step S103 preferably includes both IPv4 information and IPv6 information whether IPv4 or IPv6 is used to send the setting screen display request. For example, using SNMP makes it possible to obtain both the IPv4 information and IPv6 information of the terminal from corresponding MIBs through communication using IPv4. The information reporting message returned in step S103 is a response to the information acquisition request in step S102. When SNMP is used, the response is returned by using the MIB. When the same MIB includes multiple values, steps S102 and S103 may be repeated as many times as necessary. Steps S102 and S103 in FIG. 3 may indicate multiple exchanges between the terminal and the printer. In step S104, based on the information obtained in steps S102 and S103, the printer returns the setting form information which is a response to the setting screen display request received in step S101.

Based on the setting form information, a setting screen is displayed on the terminal. When a user specifies settings on the setting screen, a setting request is sent to the printer in step S105. In step S106, the printer sends an information acquisition request to the terminal again. In step S107, the printer obtains the terminal information from an information reporting message sent from the terminal. In step S108, based on the information obtained from the information reporting message, the printer verifies the settings and reports the verification result to the terminal.

The information acquisition request and information acquisition in steps S106 and S107 are performed to verify the settings in the setting request sent from the terminal in step S105. The communication in steps S106 and S107 is similar to that in steps S102 and S103. However, the destination of the information acquisition request in step S106 is not necessarily the terminal from which the setting request is sent. The destination of the information acquisition request depends on the content of the setting request in step S105. In other words, the destination of the information acquisition request is not limited to the address from which the setting request is sent in step S105.

Also, depending on the content of the setting screen display request in step S101 and the content of the setting request in step S105, steps S102 and S103 and steps S106 and S107 may be omitted.

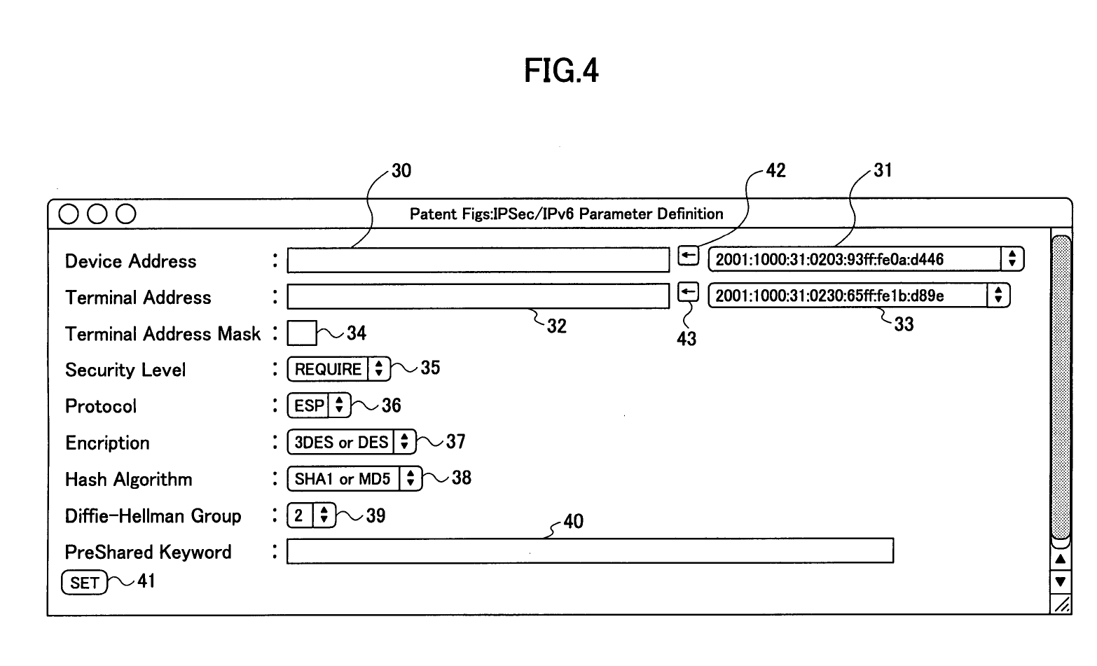

An exemplary setting screen used in the above described communication between the printer and the terminal is described below with reference to FIG. 4. The exemplary setting screen shown in FIG. 4 includes address entry fields 30 and 32, candidate address selection buttons 31 and 33, a mask entry field 34, a security level setting button 35, a protocol setting button 36, an encryption setting button 37, a hush algorithm setting button 38, a key exchange setting button 39, a key entry field 40, a SET button 41, and address entry buttons 42 and 43.

In the address entry field 30, a device address is entered. An IP address selected by the candidate address selection button 31 is entered into the address entry field 30. In the address entry field 32, a terminal address is entered. An IP address selected by the candidate address selection button 33 is entered into the address entry field 32. For example, an IP address of a printer is entered as the device address, and an IP address of a terminal is entered as the terminal address.

The candidate address selection buttons 31 and 33 are provided to prevent IP address input errors by the user. The candidate address selection buttons 31 and 33 provide appropriate IP addresses as candidates. IP addresses of a terminal, which IP addresses are obtained in steps S102 and S103, are provided by the candidate address selection button 33. Also, the user can enter IP addresses manually in the address entry fields 30 and 32.

Pressing the address entry buttons 42 and 43 enters IP addresses selected by the candidate address selection buttons 31 and 33 into the address entry fields 30 and 32.

In the mask entry field 34, the number of mask bits is entered. The security level setting button 35 is used to select a security level. The protocol setting button 36 is used to select an IPSec protocol. The encryption setting button 37 is used to select an encryption algorithm. The hush algorithm setting button 38 is used to select a hush algorithm. The key exchange setting button 34 is used to select a Diffie-Hellman Group. In the key entry field 40, a pre-shared key is entered. The SET button 41 is used to submit the settings specified in the setting screen.

If current setting information for the terminal and the printer is available, the current setting information is used as initial values in the setting screen. If there is no current setting information, an IP address of the printer which IP address is the destination of the setting screen display request may be used as the initial value for the device address, and an IP address of a terminal from which IP address the setting screen display request has been sent may be used as the initial value for the terminal address. Or, the address entry fields 30 and 32 may be left blank. Also, for the encryption and authentication methods, recommended settings may be displayed as the initial values.

According to an embodiment of the present invention, it is also possible to distinguish between an IPv4 address and an IPv6 address. For example, when a setting screen display request is sent using IPv4 to request an IPv6/IPSec setting screen, it is not appropriate to use the IPv4 addresses specified in the request packet as the initial values for the address entry fields 30 and 32. In such a case, the address entry fields 30 and 32 are left blank.

An IP address of a terminal can be obtained as described below. To obtain an IP address of a terminal, the printer sends an address information acquisition request to the terminal. For example, an IP address of the terminal can be obtained from an MIB of the terminal by using SNMP. When the setting screen display request is related to IPv6 settings, the IPv6 IP address of the terminal is obtained from its IPv6 MIP.

When the terminal has multiple addresses corresponding to multiple classes, either the address obtained first or a global address in the obtained addresses may be used.

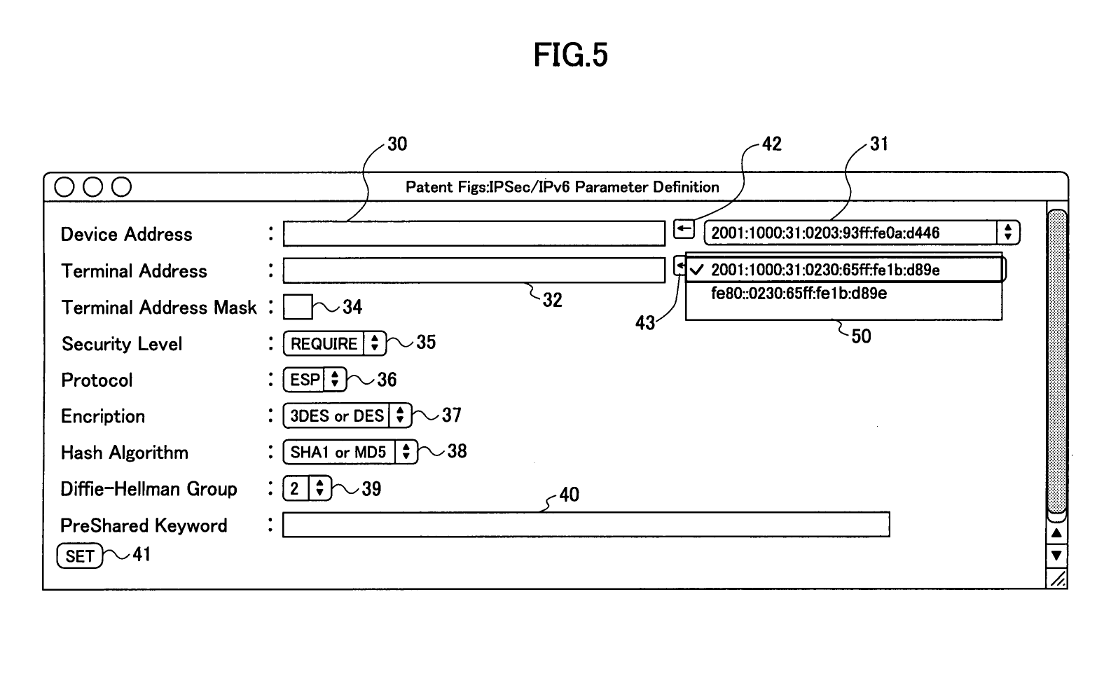

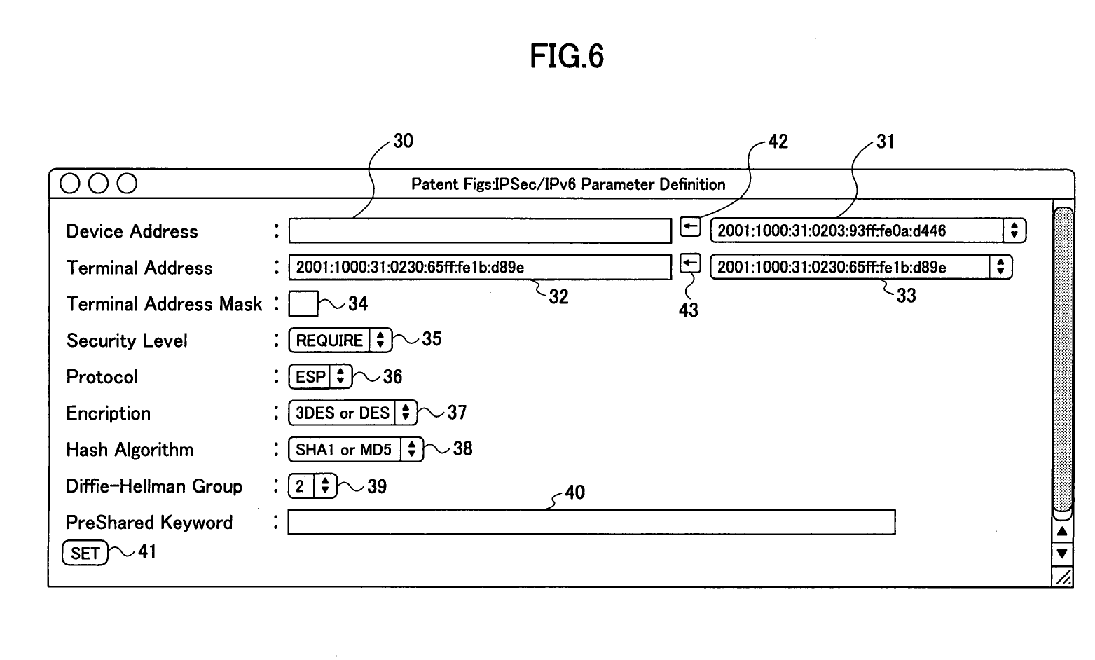

Also, as shown in FIG. 5, the setting screen may be configured to display a list of IP addresses obtained by the printer as a list 50. Further, as shown in FIG. 6, the setting screen may be configured to allow the user to modify an initial value. In this case, the user selects an address from the list 50, enters the selected address to the address entry field 32 by pressing the address entry button 43, and modifies the entered address.

The IP addresses in the list 50 are usable for the communication between the printer and the terminal. In the above case, the setting screen may be configured so that, when the printer and the terminal are in the same network segment, a local address of the terminal is included in the list 50 as shown in FIG. 5; and when the printer and the terminal are in different network segments connected by a router or the like, the local address of the terminal is not included in the list 50. When only one candidate IP address is left as a result of narrowing down the list of candidate IP addresses as described above, the remaining candidate IP address may be used as the initial value.

Also, the user can modify an IP address manually after entering the IP address into the address entry field 32 by pressing the address entry button 43.

This makes it easier to specify an address which is slightly different from that of the terminal from which the setting request is being made.

When an address other than the candidate IP addresses provided in step S104 is included in the setting request in step S105, the printer confirms the setting by obtaining information on the terminal with the specified address in steps S106 and S107.

The above described exemplary method of specifying a network parameter according to an embodiment of the present invention may also be applied to other network setting operations. In the descriptions below, static routing information setting is used as an example. Static routing information is used to control transmission routes of packets. In static routing, when a destination address of a packet is within a certain address range, the packet is sent to a router specified in the static routing information.

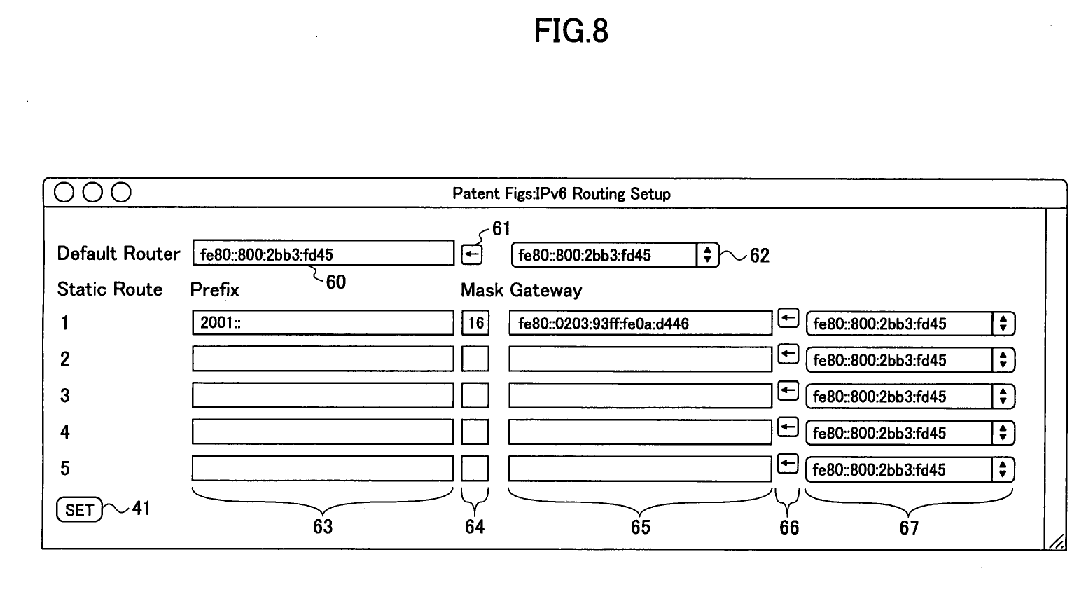

FIG. 8 is a drawing illustrating an exemplary static routing information setting screen. The exemplary static routing information setting screen shown in FIG. 8 includes an address entry field 60, a candidate address selection button 62, an address entry button 61, prefix entry fields 63, mask entry fields 64, gateway entry fields 65, address entry buttons 66, and candidate address selection buttons 67.

In the address entry field 60, an IP address of a router is entered. Pressing the address entry button 61 enters an IP address selected by the candidate address selection button 62 into the address entry field 60. Each of the prefix entry fields 63 is used to enter a prefix for a static route setting. Each of the mask entry fields 64 is used to enter the number of mask bits. Each of the gateway entry fields 65 is used to enter a gateway address. Pressing one of the address entry buttons 66 enters an IP address selected by the corresponding candidate address selection button 67 into the corresponding gateway entry field 65.

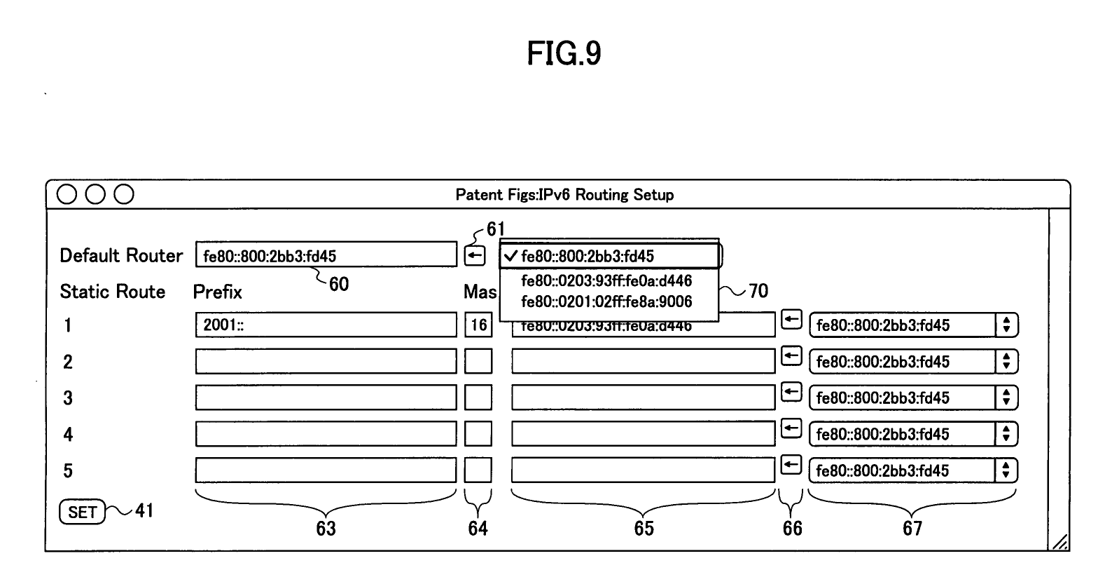

The printer makes inquiries by broadcasting a router solicitation message defined in ICMPv6 and obtains IP addresses of routers from router advertisement messages returned by the routers in response to the router solicitation message. In the router advertisement messages, addresses of the routers are contained as originating addresses. The obtained addresses are listed in a list 70 in the static routing information setting screen as shown in FIG. 9.

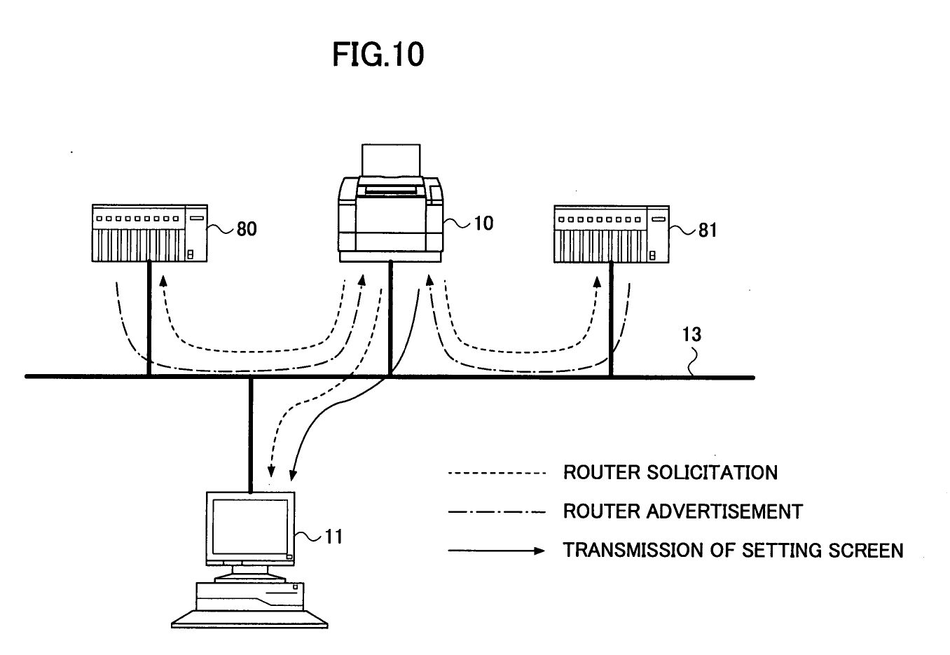

An exemplary process of obtaining router IP addresses is described below with reference to FIG. 10. The exemplary network configuration shown in FIG. 10 includes a printer 10, a terminal 11, and routers 80 and 81. In FIG. 10, the dashed lines indicate broadcast of a router solicitation message, the dashed-dotted lines indicate transmission of router advertisement messages, and the solid line indicates transmission of the static routing information setting screen to the terminal 11.

First, the printer 10 broadcasts a router solicitation message. The routers 80 and 81 return router advertisement messages. Since the terminal 11 is not a router, it does not return a router advertisement message. The printer 10 provides the terminal 11 with the router IP addresses obtained as described above.

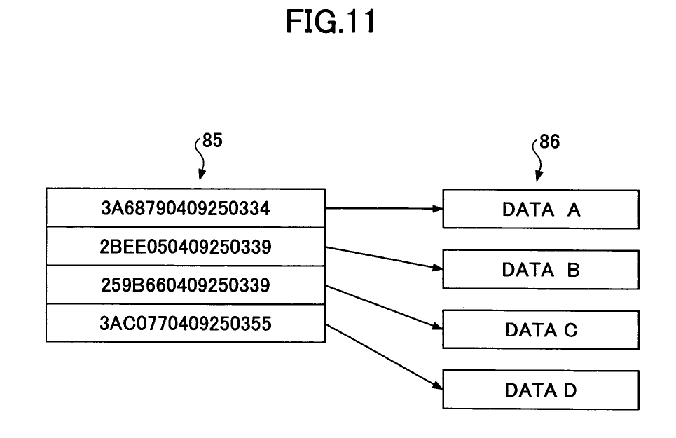

Initial value information obtained to prepare initial values for the setting forms described in the above embodiments is retained by the printer for a certain period of time together with identifiers embedded in the setting forms. For example, as shown in FIG. 11, data 85, which are the initial value information, are linked to identifiers 86 embedded in a setting form and retained by the printer.

When a display request for the same setting format is made again to the printer, the printer discards the previous initial value information and nullifies the identifiers. Such an identifier nullification process can be made efficient, for example, by using a certain identifier generation rule. For example, an identifier may include fields such as time, type of information, and type of setting form. Such fields can be used to search the identifiers retained by the printer and thereby find identifiers to be nullified and corresponding initial value information to be discarded.

When the user specifies settings in a setting form displayed on a screen and sends a setting request to the printer, identifiers embedded in the setting form are sent together with the specified settings to the printer.

When the printer receives the setting request, the printer, by using the identifiers, searches for the initial value information obtained when the setting form was sent to the terminal. If a certain period of time has passed from the time when the setting form was sent to the terminal and the initial value information has already been discarded, the printer requests the terminal to obtain the setting format and make the setting request again. Or, the printer may be configured to obtain initial value information again in a similar manner as described in FIG. 3.

The initial value information obtained as described above is used to verify the settings in the setting request sent from the terminal. For example, when an IP address other than that of the terminal itself is specified in a field for the terminal IP address, the printer displays a screen requesting a user confirmation and enables the setting only when the user confirmation is given.

Also, when an IP address not used by the printer is specified in a field for the printer IP address, the printer notifies the terminal that the specified IP address is not used by the printer and rejects the setting request.

Such a verification function provided by an embodiment of the present invention may also detect a setting error where multiple security policies are specified for the same combination of IP addresses.

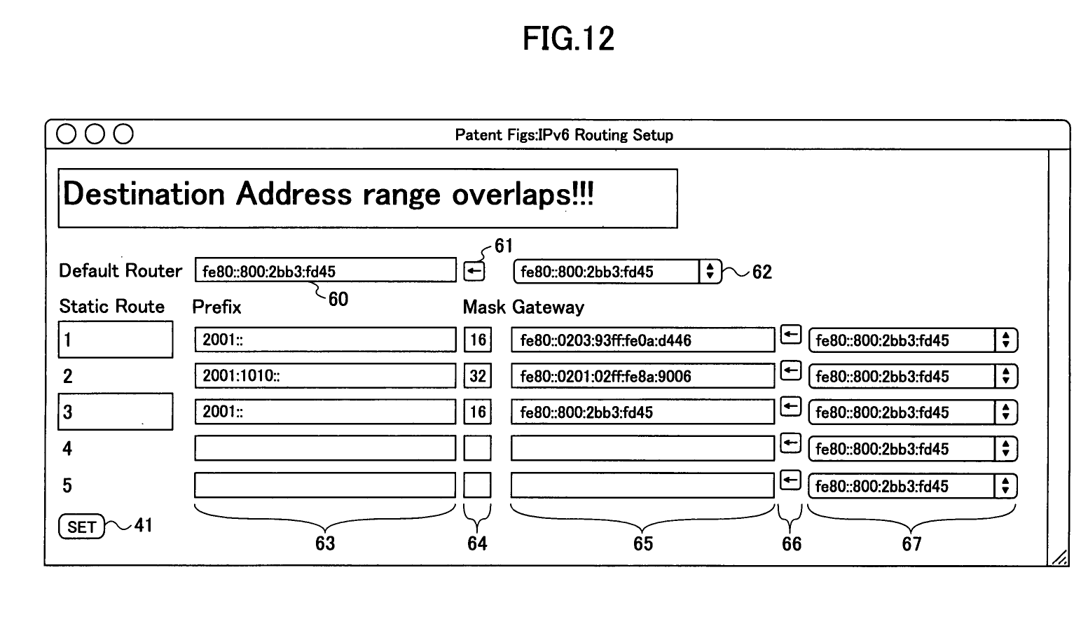

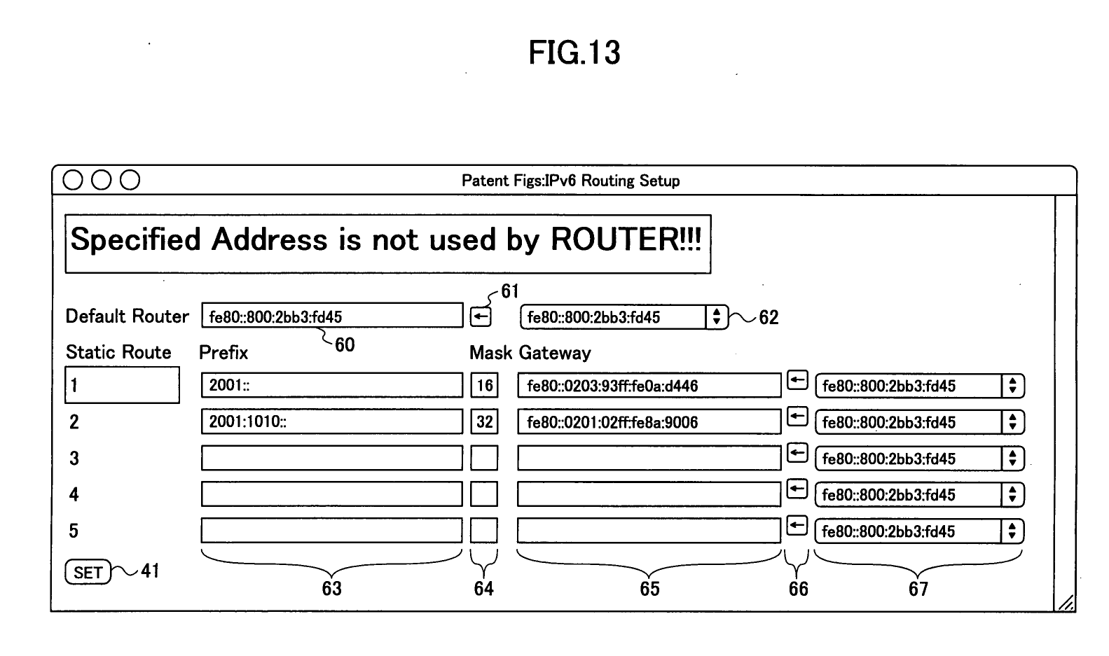

Previously, in the verification of static routing information settings, detection of obvious discrepancies as shown in FIG. 12 only had been possible. In the example shown in FIG. 12, two static route settings are provided for the same address range and the specified gateway addresses are incorrect. An embodiment of the present invention makes it possible to determine whether a specified router IP address is correct by comparing the specified router address with the router address obtained when the setting form is prepared. FIG. 13 is a drawing illustrating an exemplary static routing information setting screen according to an embodiment of the present invention where a router IP address setting error is detected.

As described above, embodiments of the present invention provide a network apparatus and a method of specifying a network parameter which make it easier for a user to enter long IPv6 IP addresses. Also, embodiments of the present invention provide a network apparatus and a method of specifying a network parameter which make it possible to detect a setting error in a more sophisticated manner than before and thereby prevent a communication failure caused by such a setting error.

The present invention is not limited to the specifically disclosed embodiments, and variations and modifications may be made without departing from the scope of the present invention.

The present application is based on Japanese Priority Application No. 2005-208635, filed on Jul. 19, 2005, the entire contents of which are hereby incorporated herein by reference.

What is claimed is:

1. A network apparatus configured to communicate with a terminal using an IP address, comprising:
an information acquisition control unit configured to obtain a first IP address to be used by the terminal to specify a parameter in a network configuration; and
a setting form generation unit configured to generate a setting screen which is to be used by the terminal to set up the network configuration and provides the terminal with the obtained first IP address.

2. The network apparatus as claimed in claim 1, wherein the information acquisition control unit obtains the first IP address by using SNMP.

3. The network apparatus as claimed in claim 1, further comprising:
a setting information verification unit configured to verify a second IP address specified using the setting screen by the terminal.

4. The network apparatus as claimed in claim 3, wherein the setting information verification unit verifies the second IP address specified by the terminal based on information contained in a packet sent from the terminal.

5. The network apparatus as claimed in claim 3, wherein the setting information verification unit verifies the second IP address specified by the terminal based on information obtained by using SNMP.

6. The network apparatus as claimed in claim 3, wherein the setting information verification unit uses identifiers linked to the first IP address and the second IP address to verify the second IP address.

7. The network apparatus as claimed in claim 6, further comprising:
a setting information retaining unit configured to retain the first IP address and the identifier linked to the first IP address.

8. The network apparatus as claimed in claim 7, further comprising:
a setting information management unit configured to manage the first IP address and the identifier linked to the first IP address which are retained by the setting information retaining unit.

9. The network apparatus as claimed in claim 8, wherein the setting information management unit removes after a specified period of time the first IP address and the identifier linked to the first IP address which are retained by the setting information retaining unit.

10. A method of specifying a network parameter using a terminal, comprising:
an information acquisition step of obtaining a first IP address to be used by the terminal to specify a parameter in a network configuration; and
a setting form generation step of generating a setting screen which is to be used by the terminal to set up the network configuration and provides the terminal with the obtained first IP address.

11. The method of specifying a network parameter as claimed in claim 10, wherein, in the information acquisition step, the first IP address is obtained by using SNMP.

12. The method of specifying a network parameter as claimed in claim 10, further comprising:
a setting information verification step of verifying a second IP address specified using the setting screen by the terminal.

13. The method of specifying a network parameter as claimed in claim 12, wherein, in the setting information verification step, the second IP address specified by the terminal is verified based on information contained in a packet sent from the terminal.

14. The method of specifying a network parameter as claimed in claim 12, wherein, in the setting information verification step, the second IP address specified by the terminal is verified based on information obtained by using SNMP.

15. The method of specifying a network parameter as claimed in claim 12, wherein, in the setting information verification step, identifiers linked to the first IP address and the second IP address are used to verify the second IP address.

16. The method of specifying a network parameter as claimed in claim 15, further comprising:
a setting information retaining step of retaining the first IP address and the identifier linked to the first IP address in a device.

17. The method of specifying a network parameter as claimed in claim 16, further comprising:
a setting information management step of managing the first IP address and the identifier linked to the first IP address which are retained in the device.

18. The method of specifying a network parameter as claimed in claim 17, wherein, in the setting information management step, the first IP address and the identifier linked to the first IP address which are retained in the device are removed after a specified period of time.
